(19) United States
(12) Patent Application Publication
(10) Pub. No.: US 2021/0291342 A1
(43) Pub. Date: Sep. 23, 2021

(54) POWER TOOL

(71) Applicant: ATLAS COPCO INDUSTRIAL TECHNIQUE AB, Stockholm (SE)

(72) Inventors: Hans Niklas GISSELMAN, Vega (SE); Thomas Roger BEJEFALK THÖRN, Stockholm (SE)

(73) Assignee: Atlas Copco Industrial Technique AB, Stockholm (SE)

(21) Appl. No.: 17/057,714

(22) PCT Filed: Apr. 26, 2019
(86) PCT No.: PCT/EP2019/060782

§ 371 Date: Nov. 23, 2020

(30) Foreign Application Priority Data
May 24, 2018 (SE) 1830171-3

(51) Int. Cl. B25F 5/00; B25F 5/02; F21V 33/00; B25F 3/00; F21Y 115/10

(52) U.S. Cl. CPC B25F 5/001; B25F 5/029; F21Y 2115/10; B25F 3/00; F21V 33/0084

(57) ABSTRACT

A power tool is arranged to operate in at least a first operating mode and a second operating mode. The power tool is operative to provide a first type of light signal from a light emitting device arranged to light up an object to be processed when the power tool is set in the first operating mode and to provide a second type of light signal when the power tool is set in the second operating mode.

### TECHNICAL FIELD

The invention relates to a power tool and a method in a power tool.

### BACKGROUND

A problem concerned with prior art power tools is that the operator sometimes makes the mistake to choose the wrong operating mode suitable for a certain application. Thus the operator believe that he/she has chosen the correct operating mode, whereas in fact the wrong operating mode has been used to perform the operation. This could have a serious negative effect on the function and/or durability of the object or structure being processed by the power tool.

In order to avoid such problems prior art power tool systems can have some sort of display giving instruction to the operator. Or give training to the operator so that the operator learns which operating mode that should be used for different applications.

These methods are however not safe enough to ensure that the power tool is set in the correct operating mode.

There is therefore a need for an improved power tool that can solve or at least mitigate the above problems.

### SUMMARY

It is an object of the present disclosure to ensure high quality of an object to be processed by providing a power tool which can ensure that the operator has chosen the correct operating mode for the object to be processed.

This object is achieved in accordance with a first aspect of the disclosure by a power tool arranged to operate in at least a first operating modes and a second operating mode. Whereby the power tool is operative to provide a first type of light signal from a light emitting device arranged to light up an object to be processed in case the power tool is set in the first operating mode and a second type of light signal in case the power tool is set in the second operating mode.

Accordingly, the object to be processed is clearly light up by a first type of light signal in case the power tool is set in the first operating mode and light up by a second type of light signal in case the power tool is set in the second operating mode. A correction of the operating mode can then be made, before the process is started, in case the power tool is set in the wrong operating mode.

In accordance with a second aspect, the present disclosure relates to a method in a power tool arranged to operate in at least a first operating modes and a second operating mode. Wherein the method comprises providing a first type of light signal from a light emitting device arranged to light up an object to be processed in case the power tool is set in the first operating mode and a second type of light signal in case the power tool is set in the second operating mode.

### BRIEF DESCRIPTION OF THE DRAWINGS

FIG. 1 which shows a view of a power tool according an exemplary embodiment of the present invention.

### DETAILED DESCRIPTION OF THE SHOWN EMBODIMENT

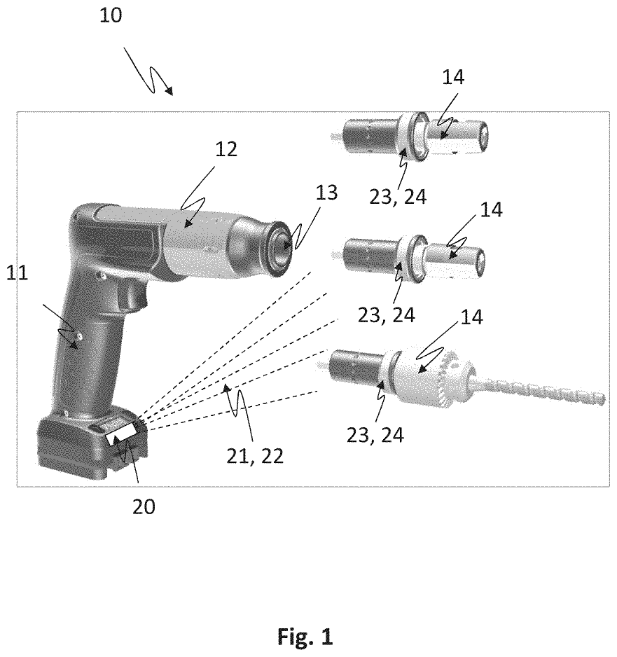

FIG. 1 illustrates a power tool 10 according to an exemplary embodiment of the present disclosure. The power tool 10 comprises a tubular housing part 12. The power tool 10 also comprises a handle 11. In one exemplary embodiment the handle 11 is substantially perpendicular to the tubular housing part 12. In other exemplary embodiments the handle 11 is line with the tubular housing part 12. An output cavity 13 is coaxially arranged within the tubular housing part 12. The output cavity 13 is arranged to detachably hold a detachable tool piece holder 14.

In this exemplary embodiment the power tool 10 is a cordless drill. Thus in this exemplary embodiment the power tool 10 is intended for drilling holes in different objects (not shown). The objects can be made of different materials. It is therefore important that the correct operating mode of the power tool 10 is chosen when drilling in different types of material. The power tool 10 is therefore arranged to operate in at least a first operating mode and a second operating mode. The power tool 10 further comprises a light emitting device 20 arranged to light up the object to be processed. In this exemplary embodiment the light emitting device 20 is arranged in the lower part of the handle of the power tool 10. An advantage with this position of the light emitting device 20 is that in case the operator also use the tubular housing part 12 as a handle, the light emitting device 20 is still able to light up the object to be processed.

The power tool 10 is operative to provide a first type of light signal 21 from a light emitting device 20 arranged to light up the object to be processed in case the power tool 10 is set in the first operating mode and a second type of light signal 22 in case the power tool 10 is set in the second operating mode.

By providing the first type of light signal 21 or the second type of light signal 22 based on which operating mode the power tool 10 is set in, the operator can easily see just by looking at the object which operating mode the power tool is set in. Thus it is easy for the operator to determine if the power tool 10 is set in the correct operating mode.

In one exemplary embodiment of the power tool 10 the first type of light signal 21 is a first color and the second type of light signal 22 is a second color. In a further exemplary embodiment of the power tool 10 the light emitting device 20 is a LED, Light Emitting Diode, arranged to emit both the first color and the second color. In another exemplary embodiment of the power tool 10 the first operating mode is first RPM, Revolutions per Minute, and the second operating mode is a second RPM.

In another exemplary embodiment of the power tool 10, the power tool 10 is further arranged to provide a third type of light signal in case the power tool fulfills yet another condition, such as e.g. being positioned perpendicular to the object to be processed and/or the power tool 10 applying the correct axial force on the object to be processed.

In another embodiment of the present disclosure the power tool 10 further comprises a from the power tool 10 detachable tool piece holder 14 comprising at least a first type of marking 23 or second type of marking 24 associated with the first or second type of light signals 21, 22.

An advantage with this embodiment is that the operator easily can see that the power tool 10 is set in the correct operating mode by comparing the first or second type of light signals 21, 22 with the first type of marking 23 or second type of marking 24.

In one exemplary embodiment of the power tool 10 the first type of marking 23 is a first color matching the first type of light signal 21 and the second type of marking 24 is a second color matching the second type of light signal 22.

The present disclosure also relates to a method, performed in the power tool 10 arranged to operate in at least a first operating modes and a second operating mode. In the method the power tool 10 provides a first type of light signal 21 from the light emitting device 20 arranged to light up the object to be processed in case the power tool is set in the first operating mode and a second type of light signal 22 in case the power tool is set in the second operating mode.

According to one exemplary embodiment of the method, the light emitting device 20 is arranged in the lower part of a handle 11 of the power tool 10.

According to another exemplary embodiment of the method, the first type of light signal 21 is a first color and the second type of light signal 22 is second color. According to yet another exemplary embodiment of the method, the power tool 10 further comprises a detachable tool piece holder 14, wherein the tool piece holder 14 comprising at least a first type of marking 23 or second type of marking 24 associated with the first type of light signal 21 or second type of light signal 22. In yet another exemplary embodiment of the method the light emitting device 20 is a LED, Light Emitting Diode, arranged to emit both the first color and the second color. In a further exemplary embodiment of the method the power tool 10 is a cordless drill. According to yet another exemplary embodiment of the method the first operating mode is a first RPM and the second operating mode is a second RPM.

The present disclosure also relates to a computer program which, when run in the power tool 10, causes the power tool 10 to perform the method as described above.

According to one exemplary embodiment, when the above-mentioned computer program code is run in a processor (not shown) of the power tool 10 it causes the power tool 10 to perform the method as described above.

1-15. (canceled)

16. A power tool configured to operate in at least a first operating mode and a second operating mode, the power tool comprising:
a housing;
a detachable tool piece holder which is detachably attached to the housing;
a light emitting device arranged to emit light to an object to be processed; and
a processor which is configured to control the light emitting device to provide a first type of light signal when the power tool is set in the first operating mode and to provide a second type of light signal when the power tool is set in the second operating mode,
wherein the detachable tool piece holder comprises at least a first type of marking or second type of marking associated with the first type of light signal or second type of light signal.

17. The power tool according to claim 16, wherein the power tool includes a handle, and the light emitting device is arranged in a lower part of the handle.

18. The power tool according to claim 16, wherein the first type of light signal is a first color and the second type of light signal is a second color.

19. The power tool according to claim 18, wherein the light emitting device is a light emitting diode (LED) configured to emit both the first color and the second color.

20. The power tool according to claim 16, wherein the power tool is a cordless drill.

21. The power tool according to claim 16, wherein the first operating mode is a first revolutions per minute (RPM) and the second operating mode is a second RPM.

22. A method in a power tool that is configured to operate in at least a first operating mode and a second operating mode, the power tool including a light emitting device that is arranged emit light to an object to be processed, the method comprising:
providing a first type of light signal from the light emitting device in the first operating mode of the power tool, and providing a second type of light signal from the light emitting device in the second operating mode of the power tool,
wherein the power tool comprises a detachable tool piece holder, and
wherein the detachable tool piece holder comprises at least a first type of marking or second type of marking associated with the first type of light signal or second type of light signal.

23. The method according to claim 22, wherein the power tool includes a handle, and the light emitting device is arranged in a lower part of the handle.

24. The method according to claim 22, wherein the first type of light signal is a first color and the second type of light signal is a second color.

25. The method according to claim 24, wherein the light emitting device is a light emitting diode (LED) configured to emit both the first color and the second color.

26. The method according to claim 22, wherein the power tool is a cordless drill.

27. The method according to claim 22, wherein the first operating mode is a first revolutions per minute (RPM) and the second operating mode is a second RPM.

28. A non-transitory recording medium storing a computer program that is executable by a processor of a power tool that is configured to operate in at least a first operating mode and a second operating mode, the power tool including a light emitting device that is arranged emit light to an object to be processed, the power tool including the power tool a detachable tool piece holder, and the program being executable by the processor to control the power tool to perform functions comprising:
providing a first type of light signal from the light emitting device when the power tool is set in the first operating mode; and
providing a second type of light signal from the light emitting device when the power tool is set in the second operating mode,
wherein the detachable tool piece holder comprises at least a first type of marking or second type of marking associated with the first type of light signal or second type of light signal.

29. The non-transitory recording medium according to claim 28, wherein the power tool includes a handle, and the light emitting device is arranged in a lower part of the handle.

30. The non-transitory recording medium according to claim 28, wherein the first type of light signal is a first color and the second type of light signal is a second color.

31. The non-transitory recording medium according to claim 30, wherein the light emitting device is a light emitting diode (LED) configured to emit both the first color and the second color.

32. The non-transitory recording medium according to claim 28, wherein the power tool is a cordless drill.

33. The non-transitory recording medium according to claim 28, wherein the first operating mode is a first revolutions per minute (RPM) and the second operating mode is a second RPM.
